(19) United States
(12) Patent Application Publication
(10) Pub. No.: US 2005/0214601 A1
(43) Pub. Date: Sep. 29, 2005

(54) Direct methanol type fuel cell power generator and operating method thereof

(75) Inventors: Kunihiko Shimizu, Miyagi (JP); Toshihiko Nishiyama, Miyagi (JP); Takashi Mizukoshi, Miyagi (JP); Masayuki Sasaki, Miyagi (JP)

Correspondence Address: FITCH, EVEN, TABIN & FLANNERY, P. O. BOX 65973, WASHINGTON, DC, 20035, US

(73) Assignee: NEC Tokin Corporation, Sendai-shi (JP)

(21) Appl. No.: 11/088,912

(22) Filed: Mar. 25, 2005

(30) Foreign Application Priority Data
Mar. 25, 2004 (JP) 2004-089021

(51) Int. Cl. H01M 8/04; H01M 8/10

(52) U.S. Cl. 429/15; 429/26; 429/30

(57) ABSTRACT

An objective of this invention is to provide to provide a direct methanol type fuel cell power generator which can operate without destruction due to water freezing or reduction in an output even when the system is exposed to a low temperature, and an operating method thereof. This invention provides a method for operating a direct methanol type fuel cell power generator, comprising the steps of feeding an aqueous methanol solution into a fuel flow path in the direct methanol type fuel cell; replacing the aqueous methanol solution in the fuel flow path with a proton-acid antifreezing liquid; and replacing the proton-acid antifreezing liquid in the fuel flow path with the aqueous methanol solution. This invention further provides a direct methanol type fuel cell power generator, comprising at least a direct methanol type fuel cell; a fuel tank filled with an aqueous methanol solution; and an antifreezing liquid tank filled with a proton-acid antifreezing liquid.

### BACKGROUND OF THE INVENTION

1. Field of the Invention

This invention relates to a direct methanol type fuel cell power generator and an operating method thereof.

2. Description of the Prior Art

A direct methanol type fuel cell (hereinafter, referred to as a “DMFC”) has been developed particularly for a compact fuel cell for a mobile device because it has a higher energy density and can dispense with a reformer for hydrogen generation, resulting in size reduction. A DMFC generates electric power by the following cell reaction.
Anode (fuel electrode): CH₃OH+H₂O→6H⁺+6e⁻+CO₂↑
Cathode (air electrode): 6H⁺+3/2O₂+6e⁻→3H₂O

Since methanol and water are essential components in the fuel electrode, an aqueous methanol solution as a fuel is fed as a liquid to a fuel flow path in the fuel electrode side. Therefore, in a fuel cell in which hydrogen is fed as a fuel (hereinafter, referred to as a “PEFC”), both sides of a membrane electrode assembly (hereinafter, referred to as an “MEA”) are gases, while in a DMFC, the fuel electrode side of an MEA is a liquid. Power generation by a DMFC is generally conducted while circulating an aqueous methanol solution. Therefore, a power generator equipped with a fuel tank for the solution and means for circulating the aqueous methanol solution is manufactured for the operation.

Water contained in the fuel cell may be frozen at a temperature of less than 0° C. In such a case, volume expansion in freezing of water may cause adhesiveness between an electrolyte membrane and a catalyst layer, leading to reduction in an output or may cause detachment of the electrolyte membrane from the catalyst layer, leading to destruction of the cell. Particularly in DMFC, since a fuel electrode is a liquid while an air electrode is a gas, there is a large difference in a volume change between the fuel and the air electrodes due to freezing of water. Thus, adhesiveness in an MEA tends to be deteriorated, so that at a lower temperature, not only power generation but also maintaining a generation halting state is difficult.

Japanese Laid-open Patent Publication No. 2002-75414 has suggested a method for preventing water freezing near a fuel electrode by increasing a methanol concentration in an aqueous methanol solution used as a fuel, utilizing freezing point depression in methanol itself. However, particularly when a methanol concentration is high, a large amount of methanol arrives an air electrode side due to a phenomenon called as “methanol crossover” in which methanol passes through an electrolyte membrane. The methanol arriving the air electrode reacts with oxygen to generate hydrogen, which causes freezing of water near the air electrode and in some cases, causes water freezing at a temperature higher than that in the fuel electrode side.

Although it is a technique for a PEFC, Japanese Laid-open Patent Publication No. 2003-187847 has described a method for filling a fuel flow path with an alcoholic material with a low freezing point such as ethyleneglycol. However, when attempting to apply the method to a DMFC, an alcoholic material with a low freezing point remaining in a fuel flow path is dissolved in an aqueous methanol solution at the time of restart. Although the alcoholic material with a low freezing point may be used as a fuel for a fuel electrode, it is less effective than methanol, resulting in a reduced output. Furthermore, a product of the cell reaction cannot be removed and is thus accumulated within the fuel flow path. It may be, therefore, one of causes which increase a cell resistance.

### SUMMARY OF THE INVENTION

An objective of this invention is, therefore, to provide a direct methanol type fuel cell power generator which can operate without destruction due to water freezing or reduction in an output even when the system is exposed to a low temperature, and an operating method thereof.

According to a first embodiment of this invention, there is provided a method for operating an apparatus generating electric power by a direct methanol type fuel cell, comprising the steps of:
(a) feeding an aqueous methanol solution into a fuel flow path in the direct methanol type fuel cell;
(b) replacing the aqueous methanol solution in the fuel flow path with a proton-acid antifreezing liquid; and
(c) replacing the proton-acid antifreezing liquid in the fuel flow path with the aqueous methanol solution.

According to a second embodiment of this invention, there is provided an apparatus generating electric power by a direct methanol type fuel cell, comprising at least
(A) a direct methanol type fuel cell;
(B) a fuel tank filled with an aqueous methanol solution; and
(C) an antifreezing liquid tank filled with a proton-acid antifreezing liquid.

According to the direct methanol type fuel cell power generator of the present invention and an operating method thereof, the generator can operate without destruction due to water freezing or reduction in an output even when the system is exposed to a low temperature.

### BRIEF DESCRIPTION OF THE DRAWINGS

FIG. 1 is a schematic view showing the structure of an exemplary direct methanol type fuel cell power generator according to this invention.

In the drawing, the symbols have the following meanings; 1: a fuel flow path, 2: an air flow path, 3: a fuel-electrode side catalyst electrode, 4: an electrolyte membrane, 5: an air-electrode side catalyst electrode, 6: a membrane electrode assembly (MEA), 7: direct methanol type fuel cell, 11: a fuel inlet, 12: a fuel outlet, 21: an air inlet, 22: an air outlet, 31: a fuel tank, 32; an antifreezing liquid tank, 33: a four-way cock, 34: a three-way cock, 35: a pump, 36: a gas inlet, 41: a gas separator, 42: a gas outlet, 51: a concentration adjusting tank, 52: a concentration controller, and 53: a methanol concentration sensor.

### DETAILED DESCRIPTION OF PREFERRED EMBODIMENTS

This invention provides a direct methanol type fuel cell power generator which can operate without destruction due to water freezing or reduction in an output even when the system is exposed to a low temperature, and an operating method thereof. Basically, it is necessary that components in an antifreezing liquid used as antifreezing means at a low temperature can be dissolved in water to lower a freezing point, is chemically stable to materials in a fuel cell and to a fuel cell reaction without adversely effects, and can pass through an electrolyte membrane to an air electrode without evaporation. In this invention, a proton-acid antifreezing liquid is used as an antifreezing liquid, taking these factors into account. Specifically, in a halting state where the system may be at a low temperature, a fuel (aqueous methanol solution) is replaced with a proton-acid antifreezing liquid, while at restarting, the liquid is replaced with the fuel. The proton-acid antifreezing liquid is chemically stable within the fuel cell and is not consumed due to evaporation during passing through the electrolyte membrane. It can be, therefore, repeatedly used.

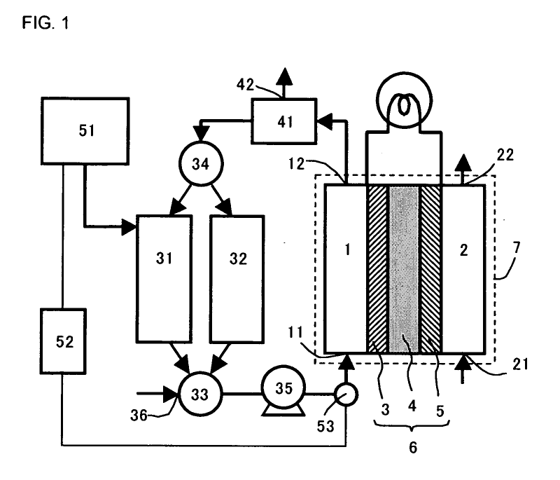

FIG. 1 is a schematic view showing the structure of an embodiment of a direct methanol type fuel cell power generator according to this invention. It will be specifically described with reference to FIG. 1. The direct methanol type fuel cell in FIG. 1 is a single cell battery, but any number of cells may be used without limitations to a cell stack structure.

A direct methanol type fuel cell power generator of this invention comprises at least a direct methanol type fuel cell (A) 7, a fuel tank (B) 31, and an antifreezing liquid tank (C) 32.

The direct methanol type fuel cell 7 comprises a membrane electrode assembly (MEA) 6 in which a fuel-electrode side catalyst electrode 3, an electrolyte membrane 4, and an air-electrode side catalyst electrode 5 are laminated. A fuel used for power generation is fed from a fuel inlet 11 to a fuel flow path 1 and then exhausted from a fuel outlet 12. On the other hand, oxygen used for power generation is fed from an air inlet 21 to an air flow path 2 and then exhausted from an air outlet 22. By the above configuration, the direct methanol type fuel cell 7 can generate electric power.

The fuel-electrode side catalyst electrode 3 and the air-electrode side catalyst electrode 5 may be a well-known electrode; for example, a carbon nonwoven fabric or carbon sheet on which a paste prepared from a catalyst carried on, e.g., carbon and a Nafion® solution is applied. A catalyst in the fuel-electrode side catalyst electrode 3 may be a Pt—Ru alloy catalyst for a DMFC. A catalyst in the air-electrode side catalyst electrode 5 may be a Pt catalyst. The electrolyte membrane 4 may be a well-known membrane; generally, a solid polymer electrolyte membrane. Examples of a solid polymer electrolyte membrane include a perfluorosulfonic acid electrolyte membrane and a hydrocarbon electrolyte membrane.

The fuel tank 31 is filled with an aqueous methanol solution as a fuel used for power generation. A concentration of the aqueous methanol solution may be appropriately determined without limitations, depending on methanol permeation performance of the electrolyte membrane 4, but is generally 0.5 to 5 mol/L.

The antifreezing liquid tank 32 is filled with a proton-acid antifreezing liquid. The proton-acid antifreezing liquid may be, for example, an aqueous sulfuric acid solution or an aqueous phosphoric acid solution, and an aqueous sulfuric acid solution is preferable in the light of its stability. There are no particular limitations to a concentration of the aqueous sulfuric acid solution. However, it is preferably 1 to 60 wt %, more preferably 10 to 30 wt % since a higher sulfuric acid concentration tends to make the solution less freezable by lowering a freezing point, but an excessively higher concentration deteriorates handling properties.

As shown in FIG. 1, the fuel tank 31 and the antifreezing liquid tank 32 are connected preferably to the fuel inlet 11 via a pump 35. The apparatus preferably further comprises a gas inlet (D) through which a gas can be fed to the fuel flow path 1. The gas inlet is preferably a gas inlet 36 disposed such that a gas can be drawn through it by the pump 35 as shown in FIG. 1, but a configuration where a gas can be introduced except without a pump may be employed. Furthermore, as shown in FIG. 1, a fuel tank 31, an antifreezing liquid tank 32 and a gas inlet 36 are preferably connected to the fuel inlet 11 via a four-way cock 33 and a pump 35 Thus, a fuel, a proton-acid antifreezing liquid and a gas can be fed into the fuel flow path 1 by the action of the pump 35 by appropriately switching the four-way cock 33.

It is preferable that the fuel tank 31 and the antifreezing liquid tank 32 are also connected to the fuel outlet 12, whereby the fuel and the proton-acid antifreezing liquid in the fuel flow path 1 can be returned. Furthermore, as shown in FIG. 1, it is preferable that the fuel tank 31 and the antifreezing liquid tank 32 are connected to the fuel outlet 12 via a gas separator 41 and a three-way cock 34. The gas separator 41 can separate a gas fed from the fuel outlet 12 to the side of the gas outlet 42, and is provided for exhausting carbon dioxide generated during power generation and gases introduced.

Preferably, the cell further comprises a concentration adjusting tank (E-1) 51 filled with a high concentration methanol solution which is connected to a fuel tank 31; a methanol concentration sensor (E-2) 53 which can measure a concentration of an aqueous methanol solution flowing through the fuel flow path 1; and a concentration control unit (E-3) 52 which can keep the concentration constant, based on the measurement by the methanol concentration sensor 53. Such a configuration can keep a concentration of the circulating aqueous methanol solution constant, even when methanol is consumed by power generation. Although the methanol concentration sensor 53 is placed just before the fuel inlet 11 in FIG. 1, it can be placed at any position, for example, within the fuel tank 31, as long as it can detect a concentration of the aqueous methanol solution flowing through the fuel flow path 1.

A high concentration methanol fed to the concentration adjusting tank 51 may be pure methanol or a high concentration aqueous methanol solution. There are no limitations to a concentration of a high concentration aqueous methanol solution as long as it is higher than that of the aqueous methanol solution used during power generation.

A direct methanol type fuel cell power generator of this invention as described above can operate avoiding destruction or output reduction due to Water freezing even when the system is exposed to a low temperature.

There will be specifically described an operating method thereof with reference to the power generator shown in FIG. 1.

First, electric power is generated using a direct methanol type fuel cell by the step (a) of feeding an aqueous methanol solution into a fuel flow path in the direct methanol type fuel cell. In the power generator in FIG. 1, the four-way cock 33 and the three-way cock 34 can be switched to the side of the fuel tank 31 to circulate the aqueous methanol solution between the fuel tank 31 and the fuel flow path 1 by the pump 35 for generating electric power. The aqueous methanol solution may be fed into the fuel flow path 1 using a syringe. During power generation, oxygen must be fed to the air flow path 2 in the side of the air electrode 5. An oxygen source is generally the air, which is fed from the air inlet 21 and exhausted from the air outlet 22. In place of the air, pure oxygen or a mixture of pure oxygen and another gas may be used.

It is preferable in parallel with power generation to keep a concentration of the circulating aqueous methanol solution constant even when methanol is consumed by power generation by the step (d) of measuring a concentration of the aqueous methanol solution flowing the fuel flow path and controlling the concentration to a constant value. In the power generator shown in FIG. 1, the methanol concentration sensor 53 placed just before the fuel inlet 11 can measure a concentration of the aqueous methanol solution flowing through the fuel flow path 1, based on which the concentration control unit 52 can control the amount of the high concentration methanol solution in the concentration adjusting tank 51 adding into the fuel tank 31 to keep a required level. When generating electric power while adjusting a concentration of the aqueous methanol solution, it is preferable that a methanol concentration in the fuel tank 31 is reduced to such a level that crossover in the electrolyte membrane 4 can be avoided by, for example, stopping concentration adjustment and conducting high-current power generation before the end of power generation.

Next, the step (b) of replacing the aqueous methanol solution in the fuel flow path with a proton-acid antifreezing liquid is carried out. For easily and reliably conducting the replacement, the step (b) is preferably divided into a step (b-1) of introducing a gas into the fuel flow path to purge the aqueous methanol solution from the fuel flow path and a step (b-2) of introducing the proton-acid antifreezing liquid into the fuel flow path. The aqueous methanol solution in the fuel flow path may be removed using a syringe and then the proton-acid antifreezing liquid may be introduced using a syringe. In the power generator shown in FIG. 1, after the end of power generation, the four-way cock 33 can be switched to the side of the gas inlet 36 for feeding the air into the fuel flow path 1 by the pump 35 to discharge the methanol fuel in the fuel flow path 1 into the fuel tank 31. The air fed can be removed by the gas separator 41 and then exhausted from the gas outlet 42. The gas fed may be, in addition to the air, an inert gas. Next, the four-way cock 33 and the three-way cock 34 can be switched to the side of the antifreezing liquid tank 32 to feed the proton-acid antifreezing liquid from the antifreezing liquid tank 32 into the fuel flow path 1 by pump 35 for filling the fuel flow path 1 with the proton-acid antifreezing liquid. Thus, by replacing the aqueous methanol solution in the fuel flow path 1 with the proton-acid antifreezing liquid, freezing of water can be prevented even when the system is exposed to a low temperature (lower than 0° C.) during a halting state.

Next, the direct methanol type fuel cell power generator is restarted by the step (c) of replacing the proton-acid antifreezing liquid in the fuel flow path with the aqueous methanol solution. For easily and reliably conducting the replacement, the step (c) is preferably divided into a step (c-1) of introducing a gas into the fuel flow path to purge the proton-acid antifreezing liquid from the fuel flow path and a step (c-2) of introducing the aqueous methanol solution into the fuel flow path, although the proton-acid antifreezing liquid in the fuel flow path may be removed using a syringe and then the aqueous methanol solution may be introduced using a syringe. In FIG. 1, after halting power generation, the four-way cock 33 can be switched to the side of the gas inlet 36 for feeding the air into the fuel flow path 1 by the pump 35 to discharge the proton-acid antifreezing liquid in the fuel flow path 1 into the antifreezing liquid tank 32. The air fed can be removed by the gas separator 41 and then exhausted from the gas outlet 42. The gas fed may be, in addition to the air, an inert gas. Then, the four-way cock 33 and the three-way cock 34 are again switched to the side of the fuel tank 31 to circulate the aqueous methanol solution between the fuel tank 31 and the fuel flow path 1 by the pump 25 for restarting.

According to the operating method of this invention described above, a direct methanol type fuel cell power generator can operate without destruction or output reduction due to water freezing even when the system is exposed to a low temperature.

### EXAMPLES

This invention will be described with reference to Examples.

Preparation of a Direct Methanol Type Fuel Cell Power Generator

A Pt—Ru alloy catalyst as a fuel electrode catalyst carried on carbon particles and a Pt catalyst as an air electrode catalyst carried on carbon particles was separately prepared. Each of the catalysts was mixed with a Nafion® solution in the same amount as that of the carried catalyst, and the mixture was stirred to prepare a paste. Each paste was applied to a carbon paper to prepare a catalyst electrode (a fuel electrode side and an air electrode side). Then, a solid polymer electrolyte membrane (Nafion®, E. I. Dupont) was sandwiched between these catalyst electrodes. The assembly was heated and pressed by a hot pressing (130° C., 10 MPa) to obtain an MEA. The MEA was used to prepare a direct methanol type fuel cell power generator having the configuration shown in FIG. 1.

### Experiment 1

### Examples 1 to 3 and Comparative Example 1

A fuel tank was filled with a 2 mol/L aqueous methanol solution as a fuel. An antifreezing liquid tank was filled with an aqueous sulfuric acid solution as a proton-acid antifreezing liquid. Concentrations of the aqueous sulfuric acid solution were 10 wt % (Example 1), 20 wt % (Example 2) and 30 wt % (Example 3). In addition, as Comparative Example 1, pure water (a concentration of the aqueous sulfuric acid solution: 0 wt %) was placed in an antifreezing tank.

The four-way cock and the three-way cock were switched to the fuel tank side to circulate the aqueous methanol solution between the fuel tank and the fuel flow path by a pump for initiating power generation. An operation temperature was 25° C. and the air was circulated in the air flow path. Furthermore, a power generation period was 1 hour.

At the end of power generation, the four-way cock was switched to the gas inlet side for feeding the air to the fuel flow path by the pump for discharging the methanol fuel in the fuel flow path into the fuel tank. The air fed was removed by a gas separator and exhausted from a gas outlet.

Then, the four-way cock and the three-way cock were switched to the antifreezing liquid tank side to feed the proton-acid antifreezing liquid from the antifreezing liquid tank into the fuel flow path by the pump for filling the fuel flow path with the proton-acid antifreezing liquid. Next, the system was kept at a low temperature (0° C., −5° C., −10° C., −15° C.) for 8 hours.

After halting at a low temperature, the four-way cock was switched to the gas inlet side to feed the air into the fuel flow path by the pump for discharging the proton-acid antifreezing liquid in the fuel flow path into the antifreezing liquid tank. The air fed was removed by the gas separator and exhausted from the gas outlet.

Next, the four-way cock and the three-way cock were again switched to the fuel tank side to circulate the aqueous methanol solution between the fuel tank and the fuel flow path by the pump for restarting. The operating conditions were as described above.

### Experiment 2

### Examples 4 to 6 and Comparative Example 2

Experiment 2 was conducted as described in Experiment 1 (these examples correspond to Examples 1 to 3 and Comparative Example 1, respectively), except the followings.

A concentration adjusting tank was filled with a 6 mol/L high concentration aqueous methanol solution. While monitoring a concentration of the circulating aqueous methanol solution during power generation by a methanol concentration sensor, a concentration control unit controlled the concentration when it was reduced to lower than 2 mol/L, by adding an appropriate amount of the high concentration aqueous methanol solution in the concentration adjusting tank into the fuel tank, for maintaining a concentration of the circulating aqueous methanol solution to 2 mol/L during power generation.

Just before the end of power generation, a high-current power generation was conducted to lower a methanol concentration in the fuel tank to such a level that crossover in an electrolyte membrane can be avoided (0.3 mol/L). Then, the power generation was terminated.

### Experiment 3

### Examples 7 to 9 and Comparative Example 3

Experiment 3 was conducted as described in Experiment 1 (these examples correspond to Examples 1 to 3 and Comparative Example 1, respectively), except that introduction of the aqueous methanol solution and the proton-acid antifreezing liquid into the fuel flow path and removal them from the fuel flow path were conducted using a syringe.

### Experiment 4

### Comparative Example 4

An experiment was conducted as described in Experiment 1, except that halting at a low temperature was conducted while the aqueous methanol solution remained in the fuel flow path without replacing the liquid in the fuel flow path with the proton-acid antifreezing liquid.

Output values in the direct methanol type fuel cell power generator at the initiation and the restart in Experiment 1 to 4 (Examples 1 to 9 and Comparative Examples 1 to 4) are summarized in Table 1. The results indicate that the direct methanol type fuel cell power generator and the operating method thereof according to the present invention can prevent destruction and output reduction due to water freezing even when the system is exposed to a low temperature.

TABLE 1
Output properties of the direct methanol type fuel cell power
generator prepared

| | Conc. of | Output values before and after halting | | | |
|---|---|---|---|---|---|
| | H₂SO₄ aq. | at some temperatures (W) [Initial/Restart] | | | |
| | (wt %) | 0° C. | −5° C. | −10° C. | −15° C. |
| Ex. 1 | 10 | 0.48/0.46 | 0.47/0.40 | N.D. | N.D. |
| Ex. 2 | 20 | 0.47/0.49 | 0.48/0.47 | 0.48/0.46 | N.D. |
| Ex. 3 | 30 | 0.49/0.48 | 0.48/0.48 | 0.48/0.49 | 0.47/0.47 |
| Ex. 4 | 10 | 0.47/0.48 | 0.48/0.43 | N.D. | N.D. |
| Ex. 5 | 20 | 0.47/0.48 | 0.45/0.47 | 0.47/0.45 | N.D. |
| Ex. 6 | 30 | 0.48/0.48 | 0.46/0.47 | 0.49/0.49 | 0.45/0.43 |
| Ex. 7 | 10 | 0.48/0.45 | 0.47/0.40 | N.D. | N.D. |
| Ex. 8 | 20 | 0.46/0.47 | 0.47/0.48 | 0.46/0.46 | N.D. |
| Ex. 9 | 30 | 0.47/0.46 | 0.46/0.48 | 0.48/0.48 | 0.46/0.45 |
| Comp. | 0 | 0.48/0.35 | N.D. | N.D. | N.D. |
| Ex. 1 | | | | | |
| Comp. | 0 | 0.47/0.34 | N.D. | N.D. | N.D. |
| Ex. 2 | | | | | |
| Comp. | 0 | 0.46/0.35 | N.D. | N.D. | N.D. |
| Ex. 3 | | | | | |
| Comp. | — | 0.45/0.46 | N.D. | N.D. | N.D. |
| Ex. 4 | | | | | |

*N.D.(not determined) means that measurement could not be conducted due to destruction caused by freezing.

Thus, a direct methanol type fuel cell power generator according to this invention has a higher energy density and can dispense with a reformer for hydrogen generation, resulting in size reduction. It is, therefore, suitable for a compact fuel cell for a mobile device.

1. A method for operating a direct methanol type fuel cell power generator, comprising the steps of:
(a) feeding an aqueous methanol solution into a fuel flow path in the direct methanol type fuel cell;
(b) replacing the aqueous methanol solution in the fuel flow path with a proton-acid antifreezing liquid; and
(c) replacing the proton-acid antifreezing liquid in the fuel flow path with the aqueous methanol solution.

2. The method for operating a direct methanol type fuel cell power generator as claimed in claim 1, wherein step (b) comprises the steps of:
(b-1) introducing a gas into the fuel flow path to purge the aqueous methanol solution from the fuel flow path; and
(b-2) introducing the proton-acid antifreezing liquid into the fuel flow path.

3. The method for operating a direct methanol type fuel cell power generator as claimed in claim 1, wherein step (c) comprises the steps of:
(c-1) introducing a gas into the fuel flow path to purge the proton-acid antifreezing liquid from the fuel flow path; and
(c-2) introducing the aqueous methanol solution into the fuel flow path.

4. The method for operating a direct methanol type fuel cell power generator as claimed in claim 1, further comprising the step of (d) measuring a concentration of the aqueous methanol solution flowing the fuel flow path and controlling the concentration to a constant value.

5. The method for operating a direct methanol type fuel cell power generator as claimed in claim 1, wherein the proton-acid antifreezing liquid is an aqueous sulfuric acid solution.

6. The method for operating a direct methanol type fuel cell power generator as claimed in claim 1, wherein the direct methanol type fuel cell comprises a solid polymer electrolyte membrane as an electrolyte membrane.

7. A direct methanol type fuel cell power generator, comprising at least
(A) a direct methanol type fuel cell;
(B) a fuel tank filled with an aqueous methanol solution; and
(C) an antifreezing liquid tank filled with a proton-acid antifreezing liquid.

8. The direct methanol type fuel cell power generator as claimed in claim 7, wherein the proton-acid antifreezing liquid is an aqueous sulfuric acid solution.

9. The direct methanol type fuel cell power generator as claimed in claim 7, wherein the direct methanol type fuel cell comprises a solid polymer electrolyte membrane as an electrolyte membrane.

10. The direct methanol type fuel cell power generator as claimed in claim 7, wherein the fuel tank and the antifreezing liquid tank are connected to a fuel inlet in the fuel flow path in the direct methanol type fuel cell via a pump.

11. The direct methanol type fuel cell power generator as claimed in claim 7, further comprising (D) a gas inlet through which a gas can be fed to the fuel flow path in the direct methanol type fuel cell.

12. The direct methanol type fuel cell power generator as claimed in claim 7, further comprising:
(E-1) a concentration adjusting tank filled with a high concentration methanol solution which is connected to a fuel tank;
(E-2) a methanol concentration sensor which can measure a concentration of an aqueous methanol solution flowing through the fuel flow path; and
(E-3) a concentration control unit which can keep the concentration constant, based on the measurement by the methanol concentration sensor.
